(19) United States
(12) Patent Application Publication
(10) Pub. No.: US 2014/0253699 A1
(43) Pub. Date: Sep. 11, 2014

(54) DISPLAY APPARATUS FOR DISPLAYING 3D IMAGES

(71) Applicants: Rainer Schafer, Wolfersdorf (DE); Peter Tho Pesch, Munchen (DE)

(72) Inventors: Rainer Schafer, Wolfersdorf (DE); Peter Tho Pesch, Munchen (DE)

(73) Assignee: INSTITUT FUR RUNDFUNKTECHNIK GMBH, Munchen (DE)

(21) Appl. No.: 14/233,513

(22) PCT Filed: Jul. 17, 2012
(86) PCT No.: PCT/EP2012/064027

§ 371 Date: Mar. 20, 2014

(30) Foreign Application Priority Data
Jul. 20, 2011 (IT) TO2011A000653

(51) Int. Cl. H04N 13/04; H04N 13/00

(52) U.S. Cl. CPC H04N 13/0497; H04N 13/0011; H04N 13/0018
USPC 348/54

(57) ABSTRACT

Recent production methods for 3D video as a general rule generate stereo images in a same phase of movement. The left and right images of a stereo pair thus image the recorded (or rendered) scene at a same point of time. Correct reproduction consequently requires the two images to be shown concurrently. This is, however, not true for all apparatuses such as, for example, 3D television sets including the so-called shutter technology, which show the left and right images in temporal succession. This temporally offset reproduction of the two stereo images results in clearly perceivable image errors. The invention describes a method for compensating such image errors. This is achieved by interpolating the images of one of the channels.

### INTRODUCTION

The invention relates to a display apparatus in accordance with the preamble of the main claim. Such an apparatus is known from a ‘White Paper’ by the company Grass Valley of April 2010, entitled ‘3D Television’.

Certain contents of the 3D images reproduced on the display apparatus involve the occurrence of image errors which have an interfering effect on the 3D experience of a person observing the display apparatus.

The invention has the object of at least partly suppressing the occurrence of certain image errors.

To this effect, the display apparatus in accordance with the invention is characterized through the features of the characterizing portion of the main claim.

The disposition of the main claim is based on the following inventive concept.

The most common method for the representation of three-dimensional images is stereoscopy, where the observer is shown a pair of images (i.e., stereo image, hence left and right image) which conveys a three-dimensional impression involving a perception of depth. In stereoscopic reproduction the depth information is i. a. contained in the magnitude of the horizontal offset of an object among the left and right image: the greater this offset, the further displaced from the plane of the reproduction apparatus toward the viewer or to the rear of the plane of reproduction the object will be perceived. The properties of recording and reproduction methods for moving 3D images (3D video) that are relevant in the context of the present invention shall now be entered upon briefly:

Moving scenes typically contain moving objects which are in a defined phase of movement on each single image (frame). The association between phase of movement of the object and frame is determined by the recording process. In 3D production the left and right images are each recorded, or rendered, at a respective particular instant (generally concurrently). Both images thus show the object in a particular phase of movement (generally a same phase of movement) and should accordingly also be reproduced by the same method (i.e., generally at a same timing). There do, however, exist different techniques of reproduction where the left and right images are shown either concurrently (polarization technique) or consecutively (shutter technique). Concurrent reproduction of the stereo image is inherently not available with the shutter technique, thus resulting in image errors which shall be described in the following.

As a known matter of fact, the shutter technique is based on temporally offset reproduction of the two channels of the stereo image (left and right channels). Here the second image (as a rule the right image) is only reproduced after the first (left) image and thus at an incorrect timing. In other words, the reproduction time of the right image does not match its reproduction position. As a result a moving object in the right image is not in the position where an observer would assume it based on the object movement. The difference between the shown place and the place matching the object movement is perceivable to the observer as a local offset of a moving object.

Interpolating the images of one of the two channels has the result that interpolated images which are better matched to the object's natural movement are generated and displayed on the display apparatus. Consequently, less image errors are perceived.

### SHORT DESCRIPTION OF THE FIGURES

The invention shall be explained by making reference to the following figures, showing in:

FIG. 1 the effect of displaying 3D images on a display apparatus,

FIG. 2 the interpolation disposition on the images of a channel,

FIG. 3 a first embodiment of a display apparatus in accordance with the invention,

FIG. 4 a flow diagram of signal processing in another embodiment of the display apparatus in accordance with the invention,

FIG. 5 yet another embodiment of the display apparatus in accordance with the invention, and

FIG. 6 various image signals generated in the display apparatus of FIG. 5.

### DESCRIPTION OF THE FIGURES

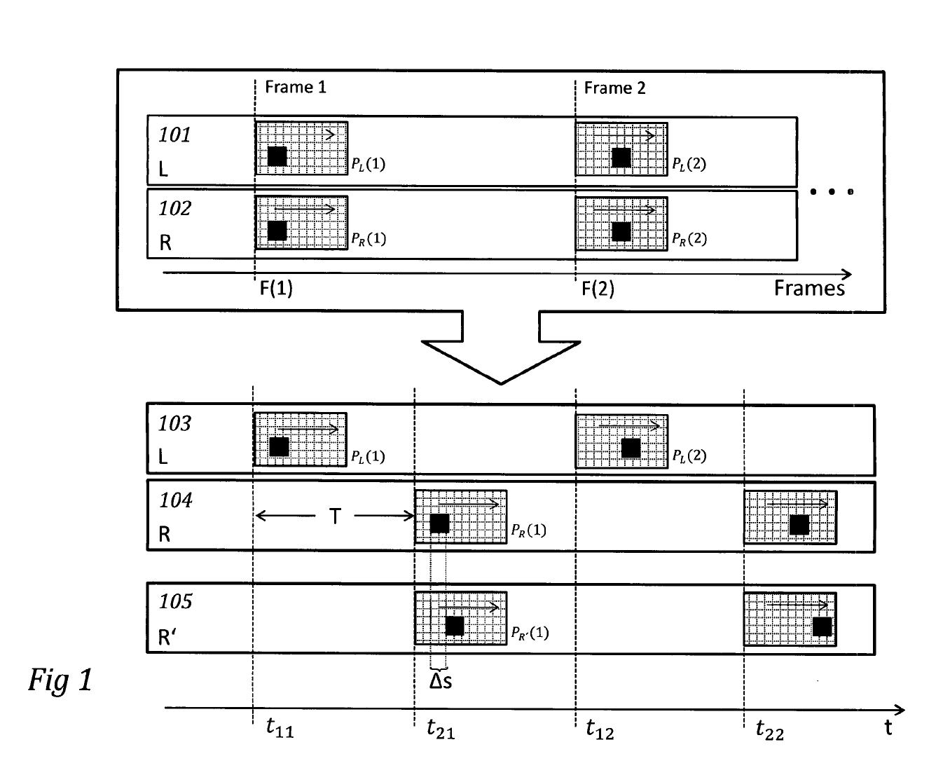

FIG. 1 shows two frames of a recording on a time axis, where the left and right channels were recorded concurrently at first times t11, t12, . . . ; cf. the consecutive images 101 for the left channel and the consecutive images 102 of the right channel. The recording contains a rectangle moving from the left to the right.

103 indicates how the images of the left channel are offered for display on the display screen.

When reproduced on a display screen, the right channel is displayed at a temporal offset relative to the left channel by a certain time difference T—see the sequence of images 104—and at the second times t21, t22. This brings about the described error. The image in the channel 105 (Rₖₒᵣᵣₑₖₜ) plotted at the lowermost position indicates the position of the rectangle as would be assumed by the observer on the basis of the movement.

The kind of generated image errors depends on the direction of the object's movement and may be differentiated into two components. Particularly grave effects come about in the case of horizontal movements, for the horizontal offset then results in a lateral disparity error and consequently in an alteration of depth of the object. Depending on the direction of movement (left, right) and the sequence of reproduction of the left and right images, the object appears to the observer to have been moved closer or removed further away. In the case of vertical movements, too, the local offset is perceivable and results in a troubled, slightly jerky image similar to the described “film judder.”

As was already mentioned at the outset, the present invention is based on the object of compensating the described image errors on the reproduction side, or at least avoiding them for the most part. Hereby it is achieved that the image material at hand is reproduced correctly—i.e., without the described image errors—on various reproduction apparatuses that display the individual images of 3D video in a time sequence manner (e.g., by means of the shutter technique). The characteristic parameters in this regard in the reproduction consist of: frame rate of the source material, the used change-over frequency at which the images of the two channels are visually displayed on the display screen, and the temporal offset between right and left images (generally 0) determined by the recording method and the time difference between the first and second times during display on the display screen (in general the second times are centrally intermediate in time between the first times).

The presently proposed dispositions are based on the approach of interpolating missing phases of movement in the image channels (as a rule only the right one) and to thus compute intermediate images which show a moving object in precisely the location that would be expected by the viewer at the time of reproduction. Due to the temporal offset in reproduction, not all of the required phases of movement exist in the original video (as a rule, all the ones of the right channel are missing). For the purpose of compensation it is possible to employ the following steps:
analyzing the temporal offset between recording and reproduction times of the individual images
computing the required intermediate images
inserting the intermediate images in the appropriate locations in the video.

Analyzing involves a temporally accurate determination of which images are present in the video and which ones are required for reproduction. From this follows which intermediate images need to be computed by interpolation for an error-free reproduction. The images of the left channel are present for displaying on the display screen at the first times. The images of the right channel are present at the second times and are thus positioned precisely intermediately between the images of the left channel.

First, in order to compute the images with the missing phases of movement (intermediate images), an estimation of movement of the objects is carried out with the aid of the temporally adjacent images. The estimation of movement describes both the path on which the corresponding object is moving and its velocity. The latter need not necessarily evolve in a linear manner but may in a first approximation be assumed to be linear.

Then the object is displaced on the path of movement by a difference As. The exact value for A s (see FIG. 1) results from the temporal offset coming about as a consequence of the temporal offset between the first times and the second times, and from the objects velocity.

The computed intermediate images are inserted in the 3D video. In addition, original images that are not required are discarded. As a general rule the intermediate images replace the right channel of the video.

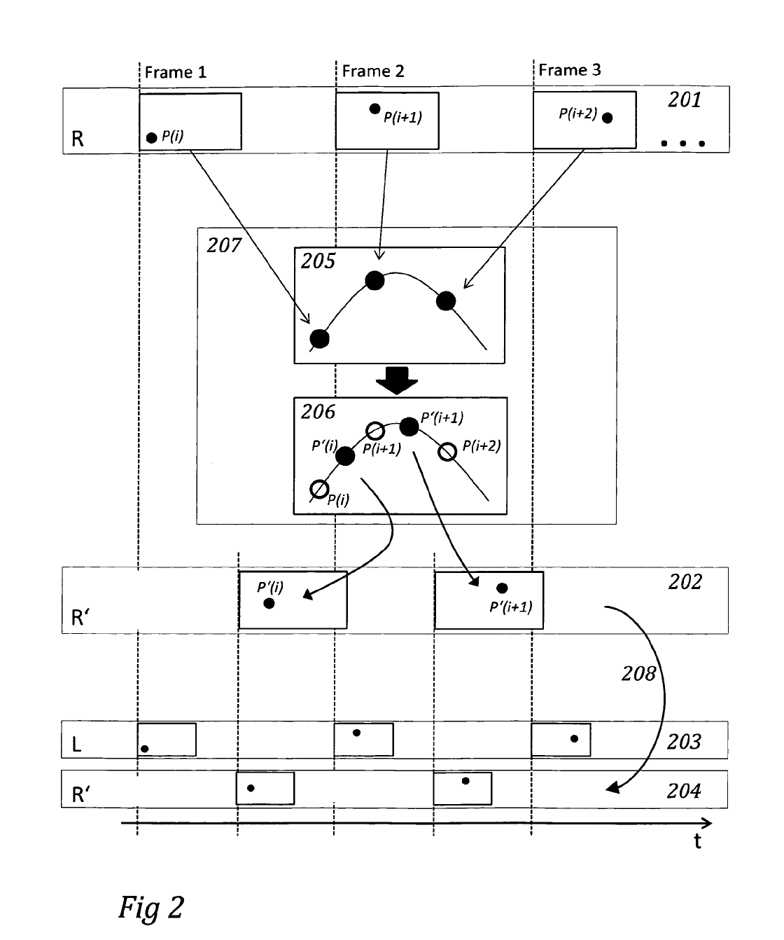

FIG. 2 shows by way of example in what manner intermediate images 202 are computed from the right channel 201 of a recording and inserted in reproduction, 203 and 204.

What is shown here in particular is an interpolation on the basis of three (in general: more than two) consecutive images P(i), P(i+1), P(i+2) of the right channel, i. a. for the reason that the interpolated objects P′(i) and P′(i+1) are situated on a curved line. In an interpolation between only two consecutive images the interpolated object would be situated on a straight line between the adjacent original objects in the two consecutive images.

In the analysis of movement it is found that the object in image P(i) is moving to the top right at an angle of about 60 degrees, the object in image P(i+1) is moving to the top right at an angle of about 30 degrees, and the object in image P(i+2) is moving to the bottom right at an angle of about 45 degrees.

In the movement correction for determining image P′(i), the object in image P(i) is shifted in the top right direction (at about 60 degrees), and the object in image P(i+1) is shifted in the bottom left direction (at about 30 degrees). In the interpolation stage the intermediate images thus obtained are computed jointly (e.g., by summing and averaging) in order to determine image P′(i).

In the movement correction for determining image P′(i+1), the object in image P(i+1) is shifted in the top right direction (at about 30 degrees), and the object in image P(i+2) is shifted in the top left direction (at about 45 degrees). In the interpolation stage the intermediate images thus obtained are computed jointly (e.g., by summing and averaging) in order to determine image P′(i+1).

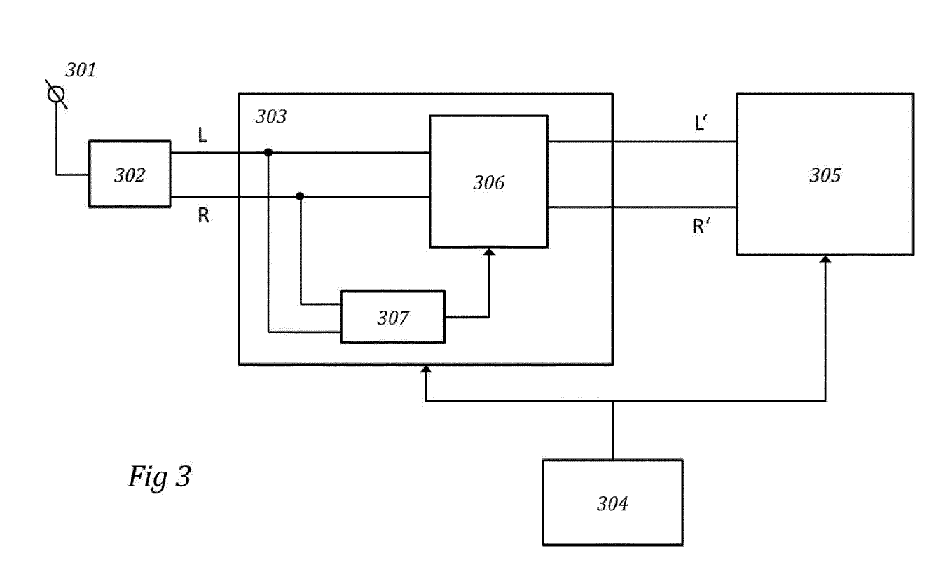

FIG. 3 schematically shows an embodiment of the display apparatus in accordance with the invention.

The display apparatus contains an input terminal 301 for receiving the 3D image signals consisting of two respective channels of image sequences for a viewer's left and right eyes. The input terminal 301 is connected to a distribution unit 302 which separates the two channels indicated by L and R out from the 3D image signals and supplies them to a control circuit 303. The control circuit generates 3D image sequences indicated by L′ and R′ which visually display the image sequences on a display screen 305 under the influence of a time evaluation 304.

The control unit drives the display screen 305 such that the images L′ (which arc generally identical with the images from the left channel L) are displayed on the display screen at the first times, and the images R′ are interpolated from the images of the right channel and, following interpolation, are displayed on the display screen 305 at the second times. To this end the control unit 303 contains an interpolation circuit 306. The said interpolation circuit generates the images (so-called intermediate images) R′ for the right channel by way of interpolation from two or more adjacent images in the original right channel R. Furthermore a determination circuit 307 might additionally be provided in the control circuit 303 in order to determine a movement velocity in consecutive images of the right channel. In this case the interpolation circuit is adapted to interpolate at least two consecutive images of the right channel in dependence on the determined movement velocity.

Image interpolation circuits are known per se, so that a more detailed explanation of the operation of the interpolation circuit 306 may be omitted.

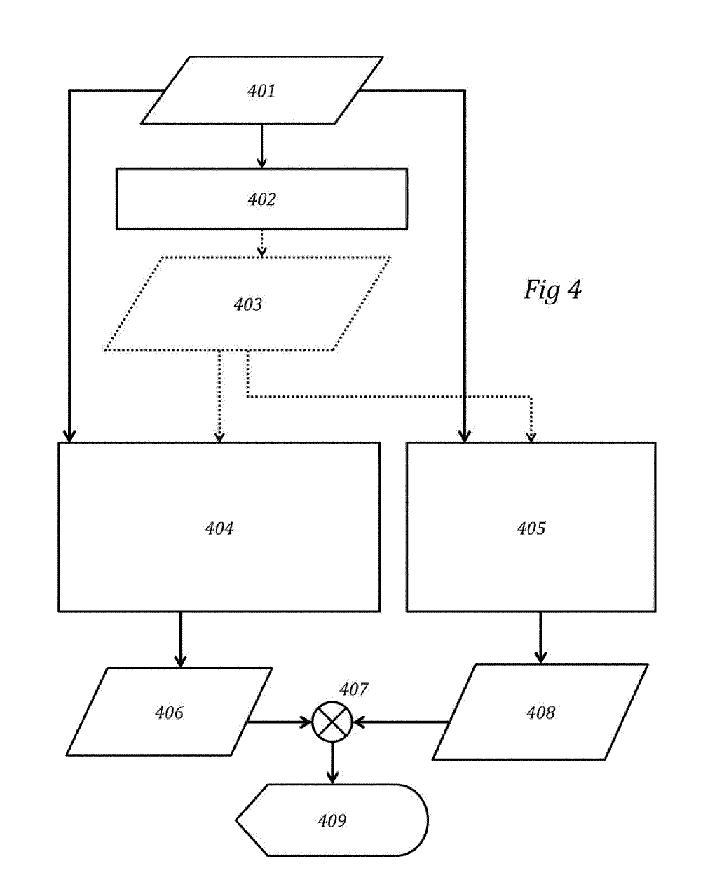

In FIG. 4 a flow diagram of signal processing in another embodiment of the display apparatus in accordance with the invention is shown.

Rectangular blocks indicate method stages. Oblique blocks indicate image or control data.

Continuous lines indicate data streams, and interrupted lines indicate information and control data streams.

Block 401 (termed ‘Source: 3D Video’) represents the incoming 3D image signals. The 3D image signals (each consisting of the right and left images) are supplied to the blocks 402, 404, and 405.

Block 402 (termed ‘Analysis of the video with regard to the reproduction method’) determines differences in recording and reproduction timings for each one of the two channels.

The information derived in block 402 (oblique block 403) drives the interpolation stage for deriving the intermediate images (block 404 termed ‘Computation of the required intermediate images by interpolation’) and a unit for removing the input images that are not required (block 405 termed ‘Discarding non-required images’). As a rule, removal from the right channel is performed for all of the input images.

The interpolated images (block 406 termed ‘Computed intermediate images’) and the non-discarded images (block 408 termed ‘Non-discarded images from the 3D video source’) are then joined together (block 407) and offered to the display screen (block 409 termed ‘Displaying on the display screen or monitor’).

There already exist current methods for the computation of intermediate images which were predominantly developed by TV set manufacturers, for instance for the mentioned 100 Hz or 200 Hz technique. It is equally employed in professional-grade standard converters for the international exchange of television signals. The quality of the computed images has in the meantime attained a high standard and is adequate for the presently described method.

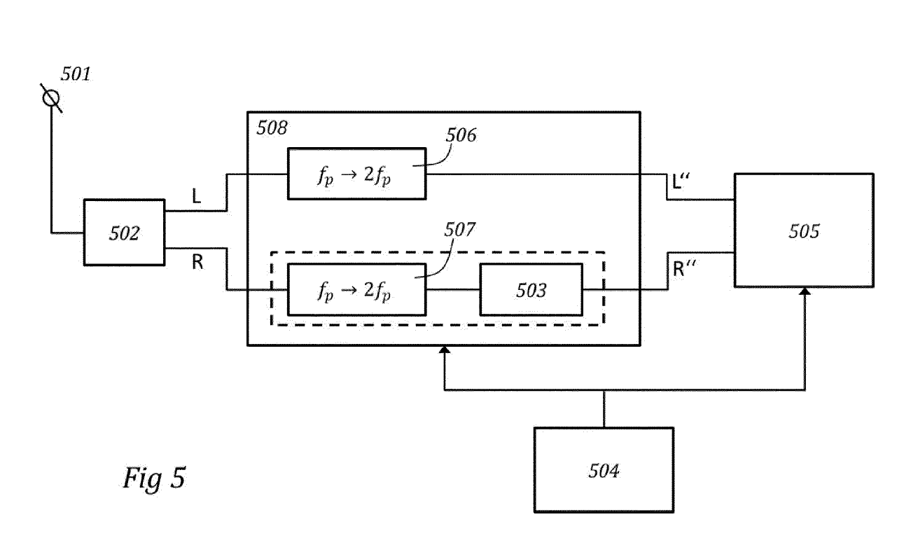

FIG. 5 shows yet another embodiment of the display apparatus in accordance with the invention. In this example the image error correction in accordance with the invention is applied to a display apparatus provided with an image frequency doubler circuit. In such apparatuses the images are received at a rate of, e.g., 50 Hz, subsequently converted to a 100 Hz image signal, to then be reproduced on a display screen.

The display apparatus contains an input terminal 501 for receiving the 3D image signals at an image frequency of, e.g., 50 Hz, consisting of two channels of image sequences for the left and the right eye of a viewer. The input terminal 501 is connected to a distribution unit 502 which separates the two channels designated by L and R out from the 3D image signals and supplies them to a control circuit 508. The control circuit 508 contains frequency doubler circuits 506 and 507 and a control unit 503. The control circuit 508 generates 3D image sequences designated by L″ and R″ that visually display the image sequences on a display screen 505 under the influence of a time evaluation 504.

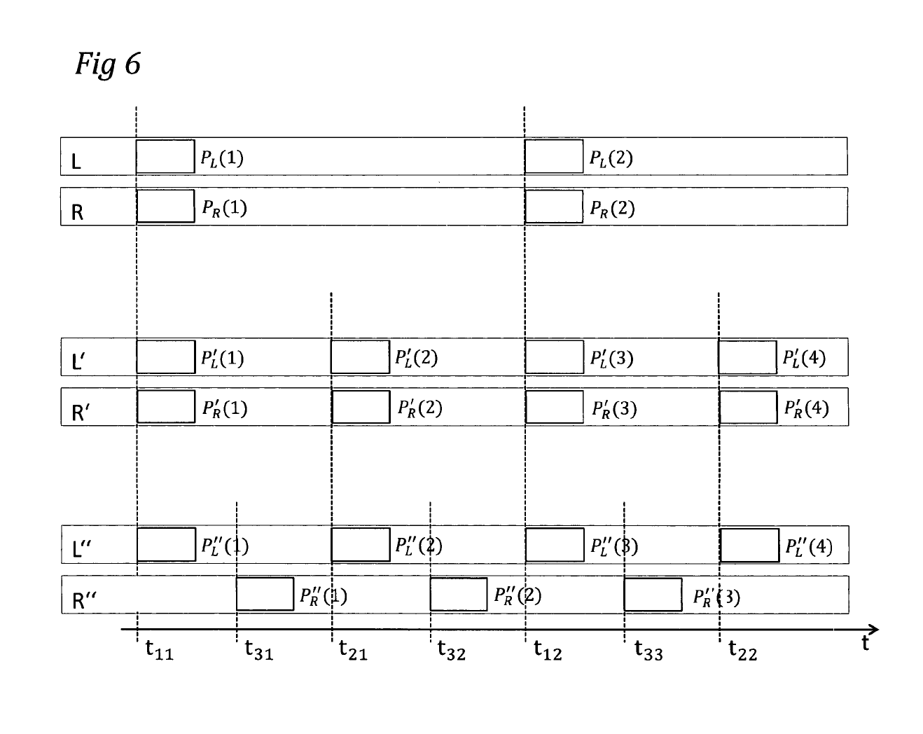

The manner of functioning of the control circuit 508 is explained further with reference to FIG. 6. In FIG. 6, L and R again designate the input image signals delivered at the output of circuit 502. The image frequency of these image signals is 50 Hz in accordance with the scenario assumed in the foregoing. The images of the two channels (images PL(1), PL(2), . . . in L and images PR(1), PR(,,), . . . in R) occur at times t11, t12, . . . .

L′ and R′ in FIG. 6 designate the respective image signals generated following image frequency doubling in circuits 506 and 508. These image signals occur at times t11, t21, t12, t22, . . . . Image frequency doubling is achieved by generating intermediate images as L′ and R′ which occur at times t21, t22, . . . . These intermediate images in the image signals L′ and R′ are derived from the image signals L and R, in a manner known per se, by interpolation on the basis of adjacent images. This means that image PL'(2) is derived by interpolation from at least the images PL(1) and PL(2). Likewise, image PR'(2) is derived by interpolation from at least the images PR(1) and PR(2). Images PL'(1) and PL'(3) may be equal to the images PL(1) and PL(2). Just the same, images PR'(1) and PR'(3) may be equal to the images PR(1) and PR(2).

L″ and R″ in FIG. 6 indicate the image signals as offered at the display screen 505. The images in image signal L″ in turn occur at times t11, t21, t12, t22, . . . and are in this case identical with the images in image signal L′. The images in image signal R″ are, however, generated by interpolation and optionally a compensation of movement in circuit 503, in the manner described in more depth in the foregoing. These images occur at times t31, t32, t33, . . . .

Thus, image PR″(1) is determined by interpolation from at least images PR′(1) and PR′(2), image PR″(2) is determined by interpolation from at least images PR′(2) and PR′(3), image PR″(3) is determined by interpolation from at least images PR'(3) and PR'(4).

This makes clear that the interpolated images in image signal R″ were lastly generated by interpolation from at least two consecutive images in the original channel R.

The control unit 504 drives the display screen 505 in such a way that the images L″ are displayed on the display screen at the first times, and the images R″ are displayed on the display screen 505 at the second times.

In the embodiment of FIG. 5 the signal processing is performed in the right channel in two stages, namely, at first the image frequency doubling in block 507 and then the interpolation and temporal shift in block 503. Here it should be mentioned, however, that the signal processing in the right channel may of course also be realized in only one step so that the intermediate images R′ do not have to be generated per se. In this embodiment the blocks 503 and 507 accordingly are not identifiable as such but executed as a single signal processing block.

It should be noted that the invention is not limited to the embodiments given in the description of the figures.

The invention thus relates to display apparatuses as claimed in the appended claims, while also relating to apparatuses in which an analysis of movement is not performed while the intermediate images are generated directly by interpolation.

1. A display apparatus for displaying 3D image signals, the 3D image signals comprising two channels of image sequences for the left and the right eye of a viewer, wherein images in each of the two channels occur at substantially equal time intervals from each other, the display apparatus comprising
a display screen for displaying the 3D image signals, and
a control unit for controlling the display screen to display the 3D image signals,
wherein the control unit is adapted to derive consecutive images from one of the two channels (L) and display the said images on the display screen at first times situated at substantially equal time intervals, and
to derive consecutive images from the other one of the two channels and display the said images on the display screen at second times situated at substantially equal time intervals, the second times being situated between the first times,
wherein the control unit comprises an interpolation circuit for interpolating in every instance at least two consecutive images in the sequence of images of the other one of the two channels in order to generate interpolated images, and in that the control unit furthermore is adapted to display the consecutive interpolated images on the display screen at the said second times.

2. The display apparatus of claim 1, wherein the control unit is further provided with a determination circuit for determining a movement speed in consecutive images of the other one of the two channels, and in that the interpolation circuit is adapted to interpolate at least two consecutive images of the other one of the two channels in dependence on the detected movement.

3. The display apparatus of claim 1, wherein the control circuit is adapted to interpolate at least two consecutive images of the other one of the two channels in dependence on a time interval between first and second times.

4. The display apparatus of claim 2, wherein the control circuit is adapted to interpolate at least two consecutive images of the other one of the two channels in dependence on a time interval between first and second times.
